(19) United States
(12) Patent Application Publication
(10) Pub. No.: US 2020/0385909 A1
(43) Pub. Date: Dec. 10, 2020

(54) CLOTHES IDENTIFICATION SYSTEM FOR WASHING MACHINES, AND BINDING METHOD AND CLOTHES IDENTIFICATION METHOD OF SAID SYSTEM

(71) Applicant: QINGDAO HAIER WASHING MACHINE CO., LTD., Shandong (CN)

(72) Inventors: Sheng XU, Shandong (CN); Junming YIN, Shandong (CN); Zhenxing HUANG, Shandong (CN); Hai SHU, Shandong (CN)

(73) Assignee: QINGDAO HAIER WASHING MACHINE CO., LTD., Shandong (CN)

(21) Appl. No.: 16/636,956

(22) PCT Filed: Aug. 10, 2018
(86) PCT No.: PCT/CN2018/099870

§ 371 Date: Mar. 9, 2020

(30) Foreign Application Priority Data
Aug. 10, 2017 (CN) 201710680019.9

(51) Int. Cl. D06F 34/05; D06F 34/18; D06F 34/34; H04L 12/24

(52) U.S. Cl. CPC D06F 34/05; D06F 34/18; D06F 2103/06; H04L 41/0803; D06F 34/34

(57) ABSTRACT

A laundry identification system of a washing machine includes a laundry identification wireless module, a mobile terminal, and a server. The laundry identification wireless module combines a laundry identification module and a wireless module to identify a laundry label and transmit label information to the server. The server receives the laundry label information, parses the laundry label information into corresponding laundry information, sends the laundry information to the washing machine and/or the mobile terminal for display, acquires washing program parameters corresponding to the laundry according to the laundry information, and sends the washing program parameters to the washing machine. The washing machine executes a washing action according to the acquired parameters. The mobile terminal receives the laundry information sent by the server, and displays the information. The laundry identification wireless module is mounted on the washing machine, so control instruction can be sent to a washing machine controller.

### TECHNICAL FIELD

The present disclosure belongs to the technical field of home designs, and particularly relates to a clothes identification system for a washing machine, and binding method a clothes identification method of said system.

### BACKGROUND

At present, all household washing machines on the market complete the washing work by control panels on the washing machines according to a program selected by a user before washing. A washing process usually includes washing time, washing temperature, a washing rotating speed, a washing water level, rinsing time, dewatering time, and the like which are stipulated by the selected program. However, these washing programs are less targeted for the care of laundry having different components. For household washing, the components of laundry are complex and changeable in composition. Ordinary users cannot make professional care judgments. This will cause uncleaned washing or waste of resources, and even serious washing damage to the laundry, such as wear, breakage, fading, staining, shrinkage, and deformation. At the same time, it is also difficult for even a laundry care expert to choose a suitable washing program for the laundry under the condition that there are a few of choices for washing programs of the washing machine.

In addition, the current washing machine is still at an exploratory stage for intelligent identification for laundry and customization of a washing program. No mature systems have been disclosed yet for the identification for laundry information and the optimal customization of the washing program.

The Chinese patent with the No. CN201410065568.1 discloses an intelligent washing method of a washing machine based on a wireless automatic identification technology. Laundry with smart labels, smart label reading equipment, intelligent information processing equipment of the washing machine, a washing machine operation display interface (a touch display screen), and a user are involved.

In view of this, the present disclosure is provided.

### SUMMARY

In order to overcome the disadvantages in the prior art, the present disclosure provides a laundry identification system of a washing machine and binding and laundry identification methods of the system. A laundry identification wireless module combining a laundry identification module and a wireless module is mounted on the washing machine to send a control instruction to a corresponding washing machine controller through a server according to laundry data, thereby realizing an intelligent washing and care function for laundry.

In order to solve the above technical problem, the basic idea of the technical solution of the present disclosure is that: a laundry identification system of a washing machine, including a laundry identification wireless module, a mobile terminal, and a server.

The laundry identification wireless module is an element combining a laundry identification module and a wireless module to identify a laundry label and transmit label information to the server.

The server receives the laundry label information, parses the laundry label information into corresponding laundry information, sends the laundry information to the washing machine and/or the mobile terminal for displaying, acquires washing program parameters corresponding to the laundry according to the laundry information, and sends the washing program parameters to the washing machine. The washing machine executes a washing action according to the acquired parameters, and the washing program parameters include a washing program, a washing water level, washing water temperature, washing time, washing rotating speed, washing rotating time, washing stop time, a number of times of rinsing, dewatering time, dewatering rotating speed, and the like.

The mobile terminal receives the information sent by the server, and displays the information to a user.

A laundry identification system of a washing machine includes a laundry identification wireless module, a mobile terminal, and a server.

The laundry identification wireless module is an element combining a laundry identification module and a wireless module to identify a laundry label and transmit label information to the server.

The server receives the laundry label information, parses the laundry label information into corresponding laundry information, and sends the laundry information to the washing machine and/or the mobile terminal for displaying.

The mobile terminal receives the laundry information sent by the server, and displays the laundry information to a user. The mobile terminal or the washing machine acquires washing program parameters according to the acquired laundry information, and the mobile terminal has a washing start function. The washing program parameters include a washing program, a washing water level, washing water temperature, washing time, washing rotating speed, washing rotating time, washing stop time, a number of times of rinsing, dewatering time, dewatering rotating speed, and the like.

The laundry identification wireless module has functions of laundry label identification and network transmission. The server has functions of data transmission and receiving, data parsing, data analysis, data storage, and data computation processing. The mobile terminal has functions of laundry information displaying and laundry information computation processing, and the mobile terminal is a mobile phone or an ipad. The washing machine holds the laundry identification wireless module, so as to receive and report data and execute a control instruction. A screen of the washing machine has functions of laundry information displaying and laundry information processing.

The identifiable label of the laundry is a Radio Frequency Identification (RFID) label. The laundry identification module is a RFID laundry identification module which is combined with the wireless module to form the RFID laundry identification wireless module. The RFID label is read conveniently and fast. Data is read without a light source, and even may be read through an external package. Label data may be dynamically changed. The RFID laundry identification module is high in identification speed, high in data capacity, long in service life, and wide in application range. The RFID laundry identification wireless module may send the control instruction to a corresponding washing machine controller through the server according to the laundry data, thereby realizing an intelligent washing and care function for the laundry

The laundry identification wireless module is an independent module, has an independent power supply, and is detachably mounted on the washing machine. Or, a mounting structure is designed by a manufacturer according to the structure and the mounting position of the module, and a corresponding power supply terminal is provided for power supplying. The laundry identification wireless module and the washing machine are not of an integrated structure, but are disposed separately, so that they are high in use sensitivity and convenient to replace.

The mobile terminal has an equipment binding function. The wireless module in the laundry identification wireless module has a network configuration mode which is a factory setting, so that the wireless module may be connected to a router through network configuration performed by the mobile terminal. A button for returning to the factory setting is arranged on the laundry identification wireless module. After the button is pressed, the laundry identification wireless module returns to the network configuration mode. The wireless module has the network configuration mode which is the factory setting, and may be directly subjected to the network configuration, thereby avoiding a step that the user adjusts the wireless module into the network configuration mode, and this is user-friendly. The button for returning to the factory setting is arranged on the laundry identification wireless module, so that if there is something wrong with the washing machine during use of the user, and the user cannot find out a cause, this button may be pressed to re-perform the network configuration.

The mobile terminal is the mobile phone or the ipad. The two mobile terminals are popular, and convenient to carry and use. The wireless module of the laundry identification wireless module is a Wi-Fi module which is widely popular, suitable for more users, simple in configuration, high in wireless speed, and relatively good in user experience.

A laundry identification wireless module configuration and binding method of a laundry identification system of a washing machine includes the following steps:

S1, enabling a laundry identification wireless module to enter a network configuration mode;

S2, connecting a mobile terminal to a router at home; S3, configuring, by the mobile terminal, the laundry identification wireless module;

S4, connecting the laundry identification wireless module to the router at home; and

S5, performing, by the mobile terminal, binding configuration on the laundry identification wireless module and the washing machine under the same network.

Specific operations of the steps S3 and S4 are as follows:

the mobile terminal configures the laundry identification wireless module to the corresponding router according to an existing softapp or a smartlink binding process to enable the laundry identification wireless module to have a networking function.

A specific operation of the step S5 is as follows:

after the step S4, the mobile terminal configures the washing machine to be under the same network and establishes a binding relationship between the laundry identification wireless module and the washing machine to enable information to be sent between the laundry identification wireless module and the washing machine.

A laundry identification method of a laundry identification system of a washing machine includes the following steps:

a user throws labeled laundry into the washing machine, or the user needs to do a laundry identification action in the vicinity of a laundry identification module when throwing the laundry;

S1, identifying, by a laundry identification wireless module, the laundry thrown by the user to acquire corresponding laundry label information;

S2, sending, by the laundry identification wireless module, the label information to a server through a wireless module;

S3, performing, by the server, data parsing according to the label data and a corresponding decoding rule to acquire information of the identified laundry, making a logic judgment and calculating program parameters according to the laundry information, returning, by the server, the laundry information to a mobile terminal or a display screen of a washing machine terminal, and returning washing program parameters to a washing machine control panel;

or, performing, by the server, data parsing according to the label data and a corresponding decoding rule to acquire information of the identified laundry, returning the laundry information to a mobile terminal or a display screen of a washing machine terminal, displaying the laundry by the mobile terminal and/or the washing machine terminal with a screen after acquiring the laundry information, calculating program parameters according to the acquired laundry information, and returning washing program parameters to a washing machine control panel;

S4, displaying the laundry by the mobile terminal and/or the washing machine terminal with a screen after acquiring the laundry information;

S5, washing the laundry by the washing machine terminal after receiving the washing program parameters.

After the washing machine terminal or the mobile terminal selects startup, a Radio Frequency Identification (RFID) laundry identification wireless module starts to work, and finally acquires the laundry information and the washing program parameters from the server. The laundry information may be checked by the user to determine whether a washing mode is correct, and the washing program parameters control the washing machine to wash the laundry to realize an exclusive washing and care function and an accurate washing and care function.

Compared with the prior art, by the adoption of the above technical solutions, the present disclosure has the following beneficial effects.

1. The RFID label is read conveniently and fast. The data is read without a light source, and even may be read through an external package. The label data may be dynamically changed.

2. The RFID laundry identification module is high in identification speed, high in data capacity, long in service life, and wide in application range.

3. The RFID laundry identification wireless module may send the control instruction to the corresponding washing machine controller through the server according to the laundry data, thereby realizing the intelligent washing and care function for the laundry.

4. The laundry identification wireless module and the washing machine are not of an integrated structure, but are disposed separately, so that they are high in use sensitivity and convenient to replace.

5. The wireless module has the network configuration mode which is the factory setting, and may be directly subjected to the network configuration, thereby avoiding the step that the user adjusts the wireless module into the network configuration mode, and this is user-friendly.

6. The button for returning to the factory setting is arranged on the laundry identification wireless module, so that if there is something wrong with the washing machine during use, and the user cannot find out a cause, this button may be pressed to re-perform the network configuration.

7. The mobile terminal is the mobile phone terminal or the ipad terminal. The two mobile terminals are popular, and convenient to carry and use.

8. The wireless module of the laundry identification wireless module is the wifi module which is widely popular, suitable for more users, simple in configuration, high in wireless speed, and relatively good in user experience.

9. The mobile terminal establishes the binding relationship between the laundry identification wireless module and the washing machine to enable information to be sent between the laundry identification wireless module and the washing machine.

10. After the washing machine terminal or the mobile terminal selects startup, the RFID laundry identification wireless module starts to work, and finally acquires the laundry information and/or the washing program parameters from the server. The laundry information may be checked by the user through the mobile terminal or the display screen of the washing machine to determine whether the washing mode is correct, and the washing program parameters control the washing machine to wash the laundry to realize the exclusive washing and care function and the accurate washing and care function.

The specific implementations of the present disclosure are further described below in detail in combination with the accompanying drawings.

### BRIEF DESCRIPTION OF THE DRAWINGS

The drawings constitute one part of the present disclosure and are used to provide a further understanding of the present disclosure. Illustrative embodiments and descriptions thereof of the present disclosure are used to explain the present disclosure, and do not constitute an improper limitation to the present disclosure. Obviously, the drawings described below are only some embodiments, and those skilled in the art can obtain other drawings according to these drawings without paying any creative work. In the drawings:

FIG. 1 is a schematic flow diagram of laundry identification of the present disclosure;

FIG. 2 is a schematic flow diagram of binding configuration of the present disclosure; and

FIG. 3 is a schematic diagram of an entire structure of a Radio Frequency Identification (RFID) laundry identification wireless module of the present disclosure.

It should be noted that these drawings and text descriptions are not intended to limit the conceptual scope of the present disclosure in any form but are to describe the concept of the present disclosure to those skilled in the art with reference to specific embodiments.

### DETAILED DESCRIPTION OF THE EMBODIMENTS

In order to make the objectives, technical solutions and advantages of the embodiments of the present disclosure clearer, the technical solutions in the embodiments will be described clearly and completely below in conjunction with the drawings in the embodiments of the present disclosure. The following embodiments are used to describe the present disclosure, but not intended to limit the scope of the present disclosure.

In the description of the present disclosure, it should be noted that orientations or positional relationships indicated by the terms “upper”, “lower”, “front”, “rear”, “left”, “right”, “vertical”, “inside”, “outside” and the like are orientations or positional relationships as shown in the drawings, and are only for the purpose of facilitating and simplifying the description of the present disclosure instead of indicating or implying that devices or elements indicated must have particular orientations, and be constructed and operated in the particular orientations, so that these terms are not construed as limiting the present disclosure.

In the description of the present disclosure, it should be noted that unless otherwise explicitly stipulated and defined, the terms “installed”, “connected”, and “coupled” need to be understood broadly, and may be, for example, fixedly connected, or detachably connected, or integrally connected, or mechanically connected, or electrically connected, or directly connected, or indirectly connected through an intermediate medium. Those of ordinary skill in the art can understand the specific meanings of the above terms in the present disclosure according to specific situations.

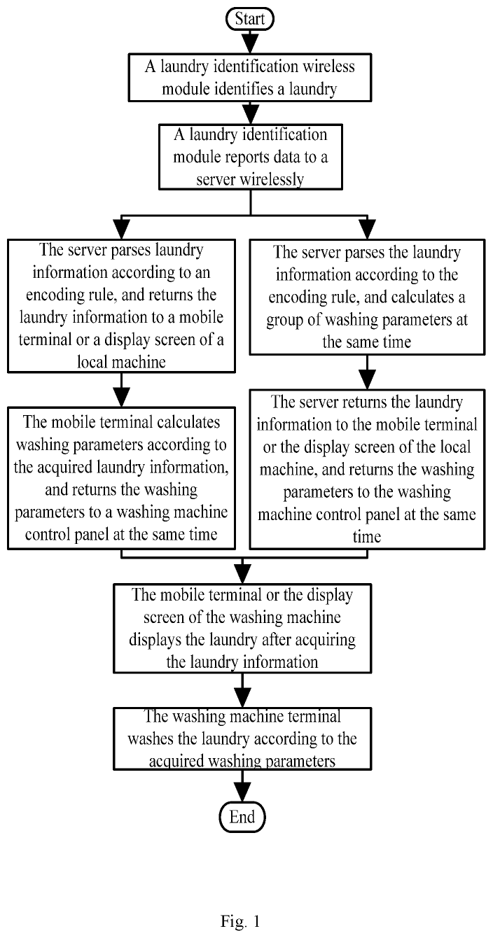

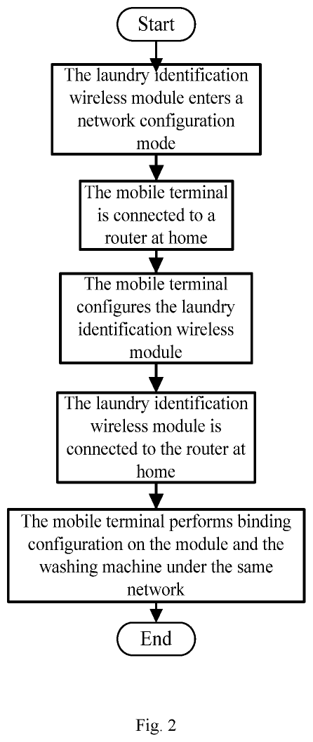

As shown in FIG. 1 and FIG. 2, a laundry identification system of a washing machine of the present disclosure includes a laundry identification wireless module, a mobile terminal, and a server.

The laundry identification wireless module is an element combining a laundry identification module and a wireless module to identify a laundry label and transmit label information to the server.

The server receives the laundry label information, parses the laundry label information into corresponding laundry information, sends the laundry information to the washing machine and/or the mobile terminal for displaying, acquires washing program parameters corresponding to the laundry according to the laundry information, and sends the washing program parameters to the washing machine. The washing machine executes a washing action according to the acquired parameters, and the washing program parameters include a washing program, a washing water level, washing water temperature, washing time, washing rotating speed, washing rotating time, washing stop time, a number of times of rinsing, dewatering time, dewatering rotating speed, and the like.

The mobile terminal receives the laundry information sent by the server, and displays the information to a user.

A laundry identification system of a washing machine includes a laundry identification wireless module, a mobile terminal, and a server.

The laundry identification wireless module is an element combining a laundry identification module and a wireless module to identify a laundry label and transmit label information to the server.

The server receives the laundry label information, parses the laundry label information into corresponding laundry information, and sends the laundry information to the washing machine and/or the mobile terminal for displaying.

The mobile terminal receives the laundry information sent by the server, and displays the laundry information to a user. The mobile terminal or the washing machine acquires washing program parameters according to the acquired laundry information, and the mobile terminal has a washing start function. The washing program parameters include a washing program, a washing water level, washing water temperature, washing time, washing rotating speed, washing rotating time, washing stop time, a number of times of rinsing, dewatering time, dewatering rotating speed, and the like.

The laundry identification wireless module has functions of laundry label identification and network transmission. The server has functions of data transmission and receiving, data parsing, data analysis, data storage, and data computation processing. The mobile terminal has functions of laundry information displaying and laundry information computation processing and is a mobile phone or an ipad. The washing machine holds the laundry identification wireless module, so as to receive and report data and execute a control instruction. A screen of the washing machine has functions of laundry information displaying and laundry information processing.

The mobile terminal has an equipment binding function. The wireless module in the laundry identification wireless module has a network configuration mode which is a factory setting, so that the wireless module may be connected to a router through network configuration performed by the mobile terminal. A button for returning to the factory setting is arranged on the laundry identification wireless module. After the button is pressed, the laundry identification wireless module returns to the network configuration mode. The wireless module has the network configuration mode which is the factory setting, and may be directly subjected to the network configuration, thereby avoiding a step that the user adjusts the wireless module into the network configuration mode, and this is user-friendly. The button for returning to the factory setting is arranged on the laundry identification wireless module, so that if there is something wrong with the washing machine during use of the user, and the user cannot find out a cause, this button may be pressed to re-perform the network configuration.

A laundry identification wireless module configuration and binding method of a laundry identification system of a washing machine includes the following steps that:

S1, a laundry identification wireless module enters a network configuration mode;

S2, a mobile terminal is connected to a router at home;

S3, the mobile terminal configures the laundry identification wireless module;

S4, the laundry identification wireless module is connected to the router at home; and

S5, the mobile terminal performs binding configuration on the laundry identification wireless module and the washing machine under the same network.

A laundry identification method of a laundry identification system of a washing machine includes the following steps that:

a user throws labeled laundry into the washing machine, or the user needs to do a laundry identification action in the vicinity of a laundry identification module when throwing the laundry;

S1, a laundry identification wireless module identifies the laundry thrown by the user to acquire corresponding laundry label information;

S2, the laundry identification wireless module sends the label information to a server through a wireless module;

S3, the server performs data parsing according to the label data and a corresponding decoding rule to acquire information of the identified laundry, and makes a logic judgment and calculates program parameters according to the laundry information; the server returns the laundry information to a mobile terminal or a display screen of a washing machine terminal, and returns washing program parameters to a washing machine control panel;

or the server performs data parsing according to the label data and a corresponding decoding rule to acquire information of the identified laundry, and returns the laundry information to a mobile terminal or a display screen of a washing machine terminal; the mobile terminal and/or the washing machine terminal with a screen displays the laundry after acquiring the laundry information, calculates program parameters according to the acquired laundry information, and returns washing program parameters to a washing machine control panel;

S4, the mobile terminal and/or the washing machine terminal with a screen displays the laundry after acquiring the laundry information;

S5, the washing machine terminal washes the laundry after receiving the washing program parameters.

After the washing machine terminal or the mobile terminal selects startup, a Radio Frequency Identification (RFID) laundry identification wireless module starts to work, and finally acquires the laundry information and the washing program parameters from the server. The laundry information may be checked by the user to determine whether a washing mode is correct, and the washing program parameters control the washing machine to wash the laundry to realize an exclusive washing and care function and an accurate washing and care function.

### Embodiment I

The identifiable label of the laundry of the present embodiment is a RFID label. The laundry identification module is a RFID laundry identification module which is combined with the wireless module to form the RFID laundry identification wireless module. The RFID label is read conveniently and fast. Data is read without a light source, is transmitted wirelessly, and even may be read through an external package. Label data may be dynamically changed. The RFID laundry identification module is high in identification speed, high in data capacity, long in service life, and wide in application range. The RFID laundry identification wireless module may send the control instruction to the washing machine and the mobile terminal through the server according to the laundry data, and the washing machine calculates the washing parameters according to the acquired laundry information or washes the laundry according to the acquired washing parameters, thereby realizing an intelligent washing and care function for the laundry.

### Embodiment II

The laundry identification wireless module of the present embodiment is an independent module, so that the user can install it on the washing machine by own. The laundry identification wireless module has an independent power supply for power supplying. Or, a mounting structure is designed by a manufacturer according to the structure and the mounting position of the module, and a corresponding power supply terminal is provided for power supplying. If the laundry identification wireless module is damaged, the user may purchase this module separately, and install it on the washing machine by own. The laundry identification wireless module and the washing machine are not of an integrated structure, but are disposed separately, so that they are high in use sensitivity and convenient to replace.

### Embodiment III

The mobile terminal of the present embodiment is the mobile phone or the ipad. The two mobile terminals are popular, and convenient to carry and use. The wireless module of the laundry identification wireless module is a Wi-Fi module which is widely popular, suitable for more users, simple in configuration, high in wireless speed, and relatively good in user experience.

### Embodiment IV

Specific operations of the steps S3 and S4 of the laundry identification wireless module configuration and binding method of the laundry identification system of the washing machine of the present embodiment are as follows:

the mobile terminal configures the laundry identification wireless module to the corresponding router according to an existing softapp or a smartlink binding process to enable the laundry identification wireless module to have a networking function.

A specific operation of the step S5 of the laundry identification wireless module configuration and binding method of the laundry identification system of the washing machine is as follows:

after the step S4, the mobile terminal configures the washing machine to be under the same network and establishes a binding relationship between the laundry identification wireless module and the washing machine to enable information to be sent between the laundry identification wireless module and the washing machine.

### Embodiment V

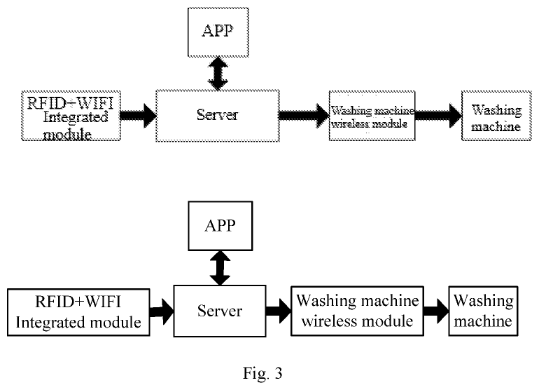

As shown in FIG. 3, the laundry identification wireless module of the present embodiment combines the RFID laundry identification module and the Wi-Fi module, and thus has a laundry label identification function, a data sending function, and a network transmission function. After detecting the laundry label, the RFID laundry identification wireless module reads the laundry label information and sends it to the server through the wireless module. The server has the data collection, processing and sending functions. After receiving the laundry data, the server parses the laundry data to acquire the corresponding laundry information, calculates the corresponding washing parameters according to the laundry information, and sends the corresponding laundry information and a corresponding washing parameter control instruction to a washing machine control panel, and the washing machine executes a corresponding washing process. The wireless module of the washing machine is in charge of receiving a command and the data from the server, and sending the command and the data to the washing machine. The mobile terminal App is in charge of network adaptation of the RFID laundry identification wireless module, and is in charge of establishing a binding relationship between the RFID laundry identification wireless module and the corresponding Internet of things washing machine and displaying the laundry information.

### Embodiment VI

When a user throws corresponding labeled laundry into the washing machine, the RFID laundry identification wireless module acquires corresponding laundry label information, and sends the label information to a background of the server through the wireless module. The server performs data parsing according to the label data and a corresponding decoding rule, and acquires information of the identified laundry. On one hand, the corresponding laundry data acquired according to the information of the identified laundry is returned to the corresponding mobile terminal or washing machine terminal for displaying; and on the other hand, a corresponding group of washing program parameters are calculated according to the laundry information and a relevant algorithm, and then are returned to the washing terminal for washing. After acquiring the laundry data, the mobile terminal displays the corresponding laundry. After receiving the laundry information, the washing machine terminal with the screen also displays the corresponding laundry.

The above descriptions are only preferred embodiments of the present disclosure, but not intended to limit the present disclosure in any forms. Although the present disclosure is disclosed above by the preferred embodiments, the preferred embodiments are not intended to limit the present disclosure. Any person skilled in the art can make some changes by using the above-mentioned technical contents or modify the technical contents as equivalent embodiments of equivalent changes without departing from the scope of the technical solution of the present disclosure. Any simple alterations, equivalent changes and modifications that are made to the above embodiments according to the technical essence of the present disclosure without departing from the contents of the technical solution of the present disclosure shall all fall within the scope of the solution of the present disclosure.

1. A laundry identification system of a washing machine, comprising a laundry identification wireless module, a mobile terminal, and a server, wherein
the laundry identification wireless module is an element combining a laundry identification module and a wireless module to identify a laundry label and transmit laundry label information to the server;
the server is for receiving the laundry label information, parsing the laundry label information into corresponding laundry information, sending the laundry information to the washing machine and/or the mobile terminal for displaying, acquiring washing program parameters corresponding to the laundry according to the laundry information, and sending the washing program parameters to the washing machine; wherein, the washing machine performs a washing action according to the washing program parameters acquired; and
the mobile terminal is for receiving the laundry information sent by the server and displaying the laundry information to a user.

2. A laundry identification system of a washing machine, comprising a laundry identification wireless module, a mobile terminal, and a server, wherein
the laundry identification wireless module is an element combining a laundry identification module and a wireless module to identify a laundry label and transmit label laundry information to the server;
the server is for receiving the laundry label information, parses the laundry label information into corresponding laundry information, and sending the laundry information to the washing machine and/or the mobile terminal for displaying; and
the mobile terminal with a washing start function is for receiving the laundry information sent by the server and displays the laundry information to a user;
wherein, the mobile terminal or the washing machine acquires washing program parameters according to the laundry information acquired.

3. The laundry identification system of the washing machine according to claim 1, wherein the laundry identification wireless module has functions of laundry label identification and network transmission;
the server has functions of data transmission and receiving, data parsing, data analysis, data storage, and data computation processing;
the mobile terminal has functions of laundry information displaying and laundry information computation processing, and the mobile terminal is a mobile phone or an ipad;
the washing machine is equipped with the laundry identification wireless module, so as to receive and report data and execute a control instruction; and a screen of the washing machine has functions of laundry information displaying and laundry information processing.

4. The laundry identification system of the washing machine according to claim 1, wherein an identifiable label of the laundry is an RFID label; the laundry identification module is an RFID laundry identification module which is combined with the wireless module to form the RFID laundry identification wireless module; and the wireless module is a Wi-Fi module.

5. The laundry identification system of the washing machine according to claim 1, wherein the laundry identification wireless module is an independent module detachably mounted on the washing machine.

6. The laundry identification system of the washing machine according to claim 1, wherein the mobile terminal has an equipment binding function; the wireless module in the laundry identification wireless module has a network configuration mode which is a factory setting, so that the mobile terminal performs network configuration to the wireless module to connect the wireless module to a router; a button for returning to the factory setting is arranged on the laundry identification wireless module; and after the button is pressed, the laundry identification wireless module returns to the network configuration mode.

7-9. (canceled)

10. A laundry identification method of a laundry identification system of a washing machine comprising the following steps:
S1, identifying, by a laundry identification wireless module, laundry thrown by the user to acquire laundry label information;
S2, sending, by the laundry identification wireless module, the laundry label information to a server through a wireless module;
S3, performing, by the server, data parsing according to label data and a corresponding decoding rule to acquire laundry information of the laundry identified, making a logic judgment and calculating program parameters according to the laundry information,
returning, by the server, the laundry information to a mobile terminal or a display screen of a washing machine terminal, and returning washing program parameters to a washing machine control panel;
or, performing, by the server, data parsing according to the label data and the corresponding decoding rule to acquire laundry information of the laundry identified, returning the laundry information to the mobile terminal or the display screen of the washing machine terminal, displaying the laundry by the mobile terminal and/or the washing machine terminal with the display screen after acquiring the laundry information, the mobile terminal and/or the washing machine terminal calculating program parameters according to the laundry information acquired and returning washing program parameters to the washing machine control panel;
S4, displaying the laundry by the mobile terminal and/or the washing machine terminal with the display screen after acquiring the laundry information; and
S5, washing the laundry by the washing machine terminal after receiving the washing program parameters.

11. The laundry identification system of the washing machine according to claim 2, wherein the laundry identification wireless module has functions of laundry label identification and network transmission;
the server has functions of data transmission and receiving, data parsing, data analysis, data storage, and data computation processing;
the mobile terminal has functions of laundry information displaying and laundry information computation processing, and the mobile terminal is a mobile phone or an ipad;
the washing machine is equipped with the laundry identification wireless module, so as to receive and report data and execute a control instruction; and a screen of the washing machine has functions of laundry information displaying and laundry information processing.

12. The laundry identification system of the washing machine according to claim 2, wherein an identifiable label of the laundry is an RFID label; the laundry identification module is an RFID laundry identification module which is combined with the wireless module to form the RFID laundry identification wireless module; and the wireless module is a Wi-Fi module.

13. The laundry identification system of the washing machine according to claim 2, wherein the laundry identification wireless module is an independent module detachably mounted on the washing machine.

14. The laundry identification system of the washing machine according to claim 2, wherein the mobile terminal has an equipment binding function; the wireless module in the laundry identification wireless module has a network configuration mode which is a factory setting, so that the mobile terminal performs network configuration to the wireless module to connect the wireless module to a router; a button for returning to the factory setting is arranged on the laundry identification wireless module; and after the button is pressed, the laundry identification wireless module returns to the network configuration mode.
